(19) United States
(12) Patent Application Publication
(10) Pub. No.: US 2026/0065892 A1
(43) Pub. Date: Mar. 5, 2026

(54) METHOD AND APPARATUS FOR MULTILINGUAL AND MULTI-SPEAKER SPEECH SYNTHESIS

(71) Applicants: HYUNDAI MOTOR COMPANY, Seoul (KR); KIA CORPORATION, Seoul (KR)

(72) Inventors: Chang Hwan Kim, Hwaseong-si (KR); Sung Woong Hwang, Hwaseong-si (KR)

(73) Assignees: HYUNDAI MOTOR COMPANY, Seoul (KR); KIA CORPORATION, Seoul (KR)

(21) Appl. No.: 19/285,697

(22) Filed: Jul. 30, 2025

(30) Foreign Application Priority Data
Aug. 28, 2024 (KR) 10-2024-0116117

(51) Int. Cl. G10L 13/027; G10L 13/08; G10L 15/00; G10L 15/06

(52) U.S. Cl. CPC G10L 13/027; G10L 13/086; G10L 15/005; G10L 15/063; G10L 2015/0635

(57) ABSTRACT

A method for multilingual and multispeaker speech synthesis includes receiving training text and a training audio signal obtained from a speaker uttering the training text. The method further includes identifying a language identifier corresponding to the training text and a training reference audio signal obtained from the speaker uttering reference text different from the training text. The method further includes training a speech synthesis model using training samples that include the training text, the training audio signal, the language identifier, and the training reference audio signal.

### CROSS-REFERENCE TO RELATED APPLICATION

This application claims the benefit of and priority to Korean Patent Application No. 10-2024-0116117, filed on Aug. 28, 2024, the entire contents of which are hereby incorporated herein by reference.

### TECHNICAL FIELD

The present disclosure relates to an apparatus and a method for multilingual and multispeaker speech synthesis.

### BACKGROUND

The content described in this section merely provides background information related to the present disclosure and may not constitute prior art.

Recent advancements in speech synthesis have led to its widespread use in various fields, including voice guidance and education. Speech synthesis is a technology that generates sounds similar to human speech and is commonly known as Text-To-Speech (TTS) system. Speech synthesis technology delivers information to the user through speech signals rather than text or images, making it particularly useful when the user is unable to see the screen of a machine in operation, such as when the user is driving a car or when the user is blind. In recent years, development and distribution of smart home devices like artificial intelligence speakers, smart TVs, and smart refrigerators, as well as personal portable devices, such as smartphones, e-book readers, and car navigation systems, have been actively pursued, leading to a rapid increase in the desire for speech synthesis techniques and devices for speech output.

Conventional speech synthesis methods include various methods such as unit selection synthesis (USS) and statistical parameter synthesis (HMM-based Speech Synthesis, HTS). The USS method segments and stores speech data into phoneme units and identifies and concatenates sound fragments suitable for speech synthesis. The HTS method extracts parameters corresponding to speech characteristics, generates a statistical model, and converts text into speech based on the statistical model.

Conventional speech synthesis methods include generating a spectrogram based on input text and generating a sound wave based on the spectrogram. Here, a spectrogram is a tool for visualizing and understanding a sound or a waveform. A spectrogram is obtained by converting an audio signal in the time domain into frequency components against the time domain axis. Based on the spectrogram, characteristics of a waveform and its spectrum may be visualized.

Furthermore, the speech synthesis method may generate sound waves that reflect speech characteristics of the speaker. The speech synthesis method may generate a speech signal corresponding to the input text based on the attributes, such as the speaker's voice, prosody, pitch, and speech rate.

Recently, a speech synthesis method that uses artificial neural networks to generate speech from text has been gaining attention.

Nevertheless, it is difficult for conventional speech synthesis models to synthesize speech for unseen speaker-language combinations. Specifically, training data used to train a conventional speech synthesis model consists of [text, speaker, language]. Because most speakers may speak in one language, it is difficult for a speech synthesis model to naturally generate speech in another language for the same speaker. For example, a speech synthesis model trained based on speech data of a man speaking English has limitations in synthesizing speech data of the same man speaking Korean.

However, the conventional speech synthesis method described above has many limitations in synthesizing natural speech that reflects the speaker's speech style or emotional expression.

Moreover, in the fields where speech synthesis systems are applied, low-quality synthesized speech, such as speech with incorrect tone or intonation, is often used without correction. Because single-speaker speech synthesis models generate the speech of only one speaker, their applications are limited to specific uses.

### SUMMARY

The present disclosure provides a device and a method for synthesizing natural speech that gives an impression that a target speaker fluently speaks text in a target language even if audio data of the target speaker in the target language is sparse or absent

The present disclosure also provides a training technique for a speech synthesis model, which may control the speech synthesis model to separate information among input factors without being overfitted to the input factors, and a speech synthesis model using the same.

An object of the present disclosure is to provide an extensible model architecture that may separate various acoustic features from a speech.

The technical objects of the present disclosure are not limited to those described above. Other technical objects not mentioned above may be more clary understood by those having ordinary skill in the art from the present disclosure.

According to an aspect of the present disclosure, a method for training a speech synthesis model is provided. The method includes receiving training text and a training audio signal obtained from a speaker uttering the training text. The method further includes identifying a language identifier corresponding to the training text and a training reference audio signal obtained from the speaker uttering reference text different from the training text. The method further includes training a speech synthesis model using training samples that include the training text, the training audio signal, the language identifier, and the training reference audio signal. Training the speech synthesis model may include transforming, by a language embedding module of the speech synthesis model, the language identifier into a language embedding. Training the speech synthesis model may include transforming, by a speaker encoder of the speech synthesis model, the training audio signal and the training reference audio signal into speaker embeddings. Training the speech synthesis model may include determining a loss based on a first speaker embedding transformed from the training reference audio signal, a second speaker embedding transformed from the training audio signal, and the language embedding. Training the speech synthesis model may include updating parameters of the speaker encoder using the loss.

According to another aspect of the present disclosure, an apparatus including at least one processor and a memory configured to store instructions is provided. The at least one processor is configured, by executing the instructions, to receive training text and a training audio signal obtained from a predetermined speaker uttering the training text. The at least one processor is further configured to identify a language identifier corresponding to the training text and a training reference audio signal obtained from the speaker uttering reference text different from the training text. The at least one processor is further configured to train a speech synthesis model by using training samples that include the training text, the training audio signal, the language identifier, and the training reference audio signal. The speech synthesis model may include a language embedding module configured to transform the language identifier into a language embedding. The speech synthesis model may further include a speaker encoder configured to transform the training audio signal and the training reference audio signal into speaker embeddings. The at least one processor is further configured to determine a loss based on a first speaker embedding transformed from the training reference audio signal, a second speaker embedding transformed from the training audio signal, and the language embedding. The at least one processor is further configured to update parameters of the speaker encoder using the loss.

According to another yet aspect of the present disclosure, a method for speech synthesis is provided. The method includes receiving a speech synthesis request including input text and information on a target speaker. The method further includes identifying a language identifier corresponding to the input text and a reference audio signal obtained from the target speaker uttering reference text different from the input text. The method further includes generating, by applying the input text, the language identifier, and the reference audio signal to a speech synthesis model, a synthesized audio signal that simulates speech by the target speaker uttering the input text. Generating the synthesized audio signal may include transforming, by a language embedding module of the speech synthesis model, the language identifier into a target language embedding. Generating the synthesized audio signal may include transforming, a speaker encoder of the speech synthesis model, the reference audio signal into a target speaker embedding. The speaker encoder may have been trained by using a loss determined based on speaker embeddings transformed from a plurality of training audio signals from a speaker and a language embedding transformed from training text corresponding to one of the plurality of training audio signals.

According to another yet aspect of the present disclosure, an apparatus including at least one processor and a memory configured to store instructions is provided. The at least one processor is configured, by executing the instructions, the instructions cause the device to receive a speech synthesis request including input text and information on a target speaker. The at least one processor is further configured to identify a language identifier corresponding to the input text and a reference audio signal obtained from the target speaker uttering reference text different from the input text. The at least one processor is further configured to generate, by applying the input text, the language identifier, and the reference audio signal to a speech synthesis model, a synthesized audio signal that simulates speech by the target speaker uttering the input text. The speech synthesis model may include a language embedding module configured to transform the language identifier into a target language embedding. The speech synthesis model may further include a speaker encoder configured to transform the reference audio signal into a target speaker embedding. The speaker encoder may have been trained by using a loss determined based on speaker embeddings transformed from a plurality of training audio signals from a speaker and a language embedding transformed from training text corresponding to one of the plurality of training audio signals.

### BRIEF DESCRIPTION OF THE DRAWINGS

FIG. 1 illustrates the structure of a vehicle according to one embodiment of the present disclosure.

FIG. 2 illustrates a speech synthesis according to one embodiment of the present disclosure.

FIG. 3 illustrates the operation of a speech synthesis device according to one embodiment of the present disclosure.

FIG. 4 illustrates training of a speech synthesis model according to one embodiment of the present disclosure.

FIG. 5 illustrates a metric learning loss between speaker embedding and language embedding according to one embodiment of the present disclosure.

FIG. 6 illustrates the operation of a speech synthesis model according to one embodiment of the present disclosure.

FIG. 7 illustrates one example of a language normalized affine coupling layer according to one embodiment of the present disclosure.

FIG. 8 illustrates one example of a language denormalized affine coupling layer according to one embodiment of the present disclosure.

FIG. 9 is a flow diagram illustrating a method for training a speech synthesis model according to one embodiment of the present disclosure.

FIG. 10 is a flow diagram illustrating a speech synthesis method according to one embodiment of the present disclosure.

FIG. 11 is a block diagram briefly illustrating a computing device that may be used for implementing an apparatus and methods according to the present disclosure.

### DETAILED DESCRIPTION

Hereinafter, embodiments of the present disclosure are described in detail with reference to the accompanying drawings. In the accompanying drawings, like reference numerals designate like elements even when the elements are shown in different drawings. Further, in the present disclosure, a detailed description of known functions and configurations incorporated therein has been omitted for the purpose of clarity and for brevity.

Various terms, such as first, second, A, B, (a), (b), etc., are used solely to differentiate one component from the other but not to imply or suggest the substances, order, or sequence of the components. Throughout the present disclosure, when a part ‘includes’ or ‘comprises’ a component, the part is meant to further include other components and is not intended to exclude other components unless specifically stated to the contrary.

Terms, such as ‘unit’, ‘module’, and the like, refer to one or more components for processing at least one function or operation, which may be implemented by hardware, software, or a combination thereof. When a component, device, module, element, or the like of the present disclosure is described as having a purpose or performing an operation, function, or the like, the component, device, or element should be considered herein as being “configured to” meet that purpose or perform that operation or function. Each controller, unit, module, component, device, element, and the like may separately embody or be included with a processor and a memory, such as a non-transitory computer readable media, as part of the apparatus.

The following detailed description, together with the accompanying drawings, is intended to describe example embodiments of the present disclosure and is not intended to represent the only embodiments in which the present disclosure may be practiced.

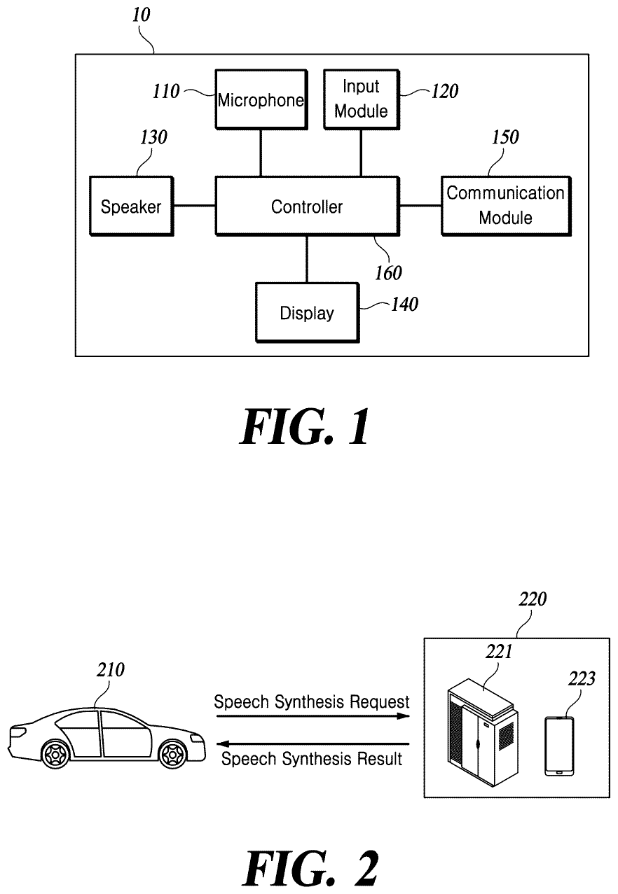

FIG. 1 illustrates the structure of a vehicle according to an embodiment of the Referring to FIG. 1, a vehicle 10 may include all or some of a microphone 110 through which a user's voice is input, an input module 120 receiving vehicle information, a speaker 130 outputting a sound necessary for providing a service desired by the user, a display 140 displaying an image necessary for providing a service desired by the user, a communication module 150 performing communication with an external device, and a controller 160 controlling the constituting elements above and other constituting elements of the vehicle.

The microphone 110 may be provided at a location inside the vehicle 10 where the user's voice is input. The user who inputs voice into the microphone 110 provided in the vehicle 10 may be the driver. The microphone 110 may be installed at a location, such as the steering wheel, center fascia, headlining, or rearview mirror, to receive the driver's voice.

In addition to the user's voice, various audio sounds generated around the microphone 110 may be input to the microphone 110. The microphone 110 may output an audio signal corresponding to the input audio signal. The output audio signal may be processed by the controller 160 or transmitted to an external server device through the communication module 150.

In addition to the microphone 110, the vehicle 10 may include the input module 120 for receiving user commands. The input module 120 may be provided in the form of a button or a jog shuttle in the cluster area, the Audio, Video, Navigation (AVN) area of the center fascia, the gearbox area, or the steering wheel.

Also, to receive control commands related to the passenger seat, the input module 120 may include an interface device provided on the door of each seat and an interface device provided on the armrest of the front seat or the armrest of the rear seat.

Also, the input module 120 may include a touch pad integrated with the display 140 to implement a touch screen.

Also, the input module 120 may include a camera. The camera may acquire at least one of an internal image or an external image of the vehicle 10. The camera may be installed inside, outside, or both inside and outside of the vehicle 10. The images collected by the camera are processed by the controller 160 or an external server device. Based on the collected images, the gaze, mouth shape, face, behavior, or state of the occupant in the video may be analyzed.

The speaker 130 may output an electrical signal in the form of a sound wave. The speaker 130 may be disposed to face the inside of the vehicle 10 near each door, roof, front window, or rear window. The speaker 130 may refer to various types of speakers, such as loudspeakers and array speakers.

The display 140 may include an AVN display, a cluster display, or a head-up display (HUD) provided on the center fascia of the vehicle 10. Alternatively, the display 140 may include a rear seat display provided on the back of the headrest of the front seat for passengers in the rear seat. Alternatively, when the vehicle 10 is a multi-passenger vehicle, the display 140 may include a display mounted on the headlining.

The display 140 may be provided in locations where the occupants of the vehicle 10 may see it, and there are no other restrictions on the number or location of the displays 140.

The communication module 150 may exchange signals with other devices by employing at least one of various wireless communication methods such as Bluetooth, 4G communication, 5G communication, or Wi-Fi. Alternatively, the communication module 150 may exchange information with other devices through a cable connected to a Universal Serial Bus (USB) port, auxiliary (AUX) port, and so on.

Also, the communication module 150, by being equipped with two or more communication interfaces that support different communication methods, may exchange information signals with two or more other devices.

For example, the communication module 150 may communicate with a mobile device located inside the vehicle 10 through Bluetooth communication to receive information (user's video, voice, contact information, schedule, and so on) obtained by the mobile device or stored therein, may transmit the user's voice by communicating with the server through the 4G or 5G communication, and may receive signals necessary to provide a service desired by the user. Also, the communication module 150 may exchange necessary signals with the server through a mobile device connected to the vehicle 10.

In addition to the above, the vehicle 10 may include a navigation device for providing route guidance, an air conditioning device for controlling the internal temperature, a window control device for controlling opening/closing of windows, a seat heating device for warming up the seats, a seat positioning device for adjusting the position, height, or angle of the seats, and a lighting device for adjusting internal illumination.

The devices described above provide convenience functions related to the vehicle 10, and some of the devices may be omitted depending on the vehicle model and options. Also, it should be noted that other devices may be included in addition to the devices described above. For driving of the vehicle 10, well-known configurations are employed, and descriptions thereof have been omitted from the present disclosure.

The controller 160 may turn on/off the microphone 110 and may process or store the voice input to the microphone 110 and/or may transmit the input voice to another device through the communication module 150.

Also, the controller 160 may control images to be displayed on the display 140 and may control sounds to be output to the speaker 130.

Also, the controller 160 may perform various control operations related to the vehicle 10. For example, according to a user's command input through the microphone 110 or the input module 120, the controller 160 may control at least one of the navigation device, the air conditioning device, the window control device, the seat heating device, the seat positioning device, or the lighting device.

The controller 160 may include at least one memory that stores a program for performing the operation above as well as those described below. The controller 160 may also include at least one processor that executes the stored program.

The controller 160 may operate as a speech synthesis device. For example, a user may request audio output so that the text displayed on the display 140 is spoken in a specified language by a selected speaker. The user's desired language and speaker may be set in advance.

In some examples, the controller 160 may synthesize speech corresponding to the text by converting the text into an audio signal based on the selected language and the selected speaker. For example, a user may want to hear the English text “Directions to home will be provided” spoken in a Korean voice, e.g., the accent or intonation of a Korean speaker reading English. The controller 160 may retrieve a pre-stored audio sample of the Korean voice and may apply a speech synthesis model to the English text and the audio sample. The speech synthesis model may generate audio signals that make the English text sound as if it is naturally spoken by a Korean voice. The audio signal may be output through the speaker 130. The user may hear the English text spoken naturally by a selected Korean speaker.

In another example, the controller 160 may perform speech-based questions and answers by synthesizing and transforming a response to a user's question into an audio signal according to a preset speaker. For example, if a user inputs a question, “What is ‘Encantado de conocerlo’ in English?” through the microphone 110, the controller 160 may generate “It's ‘Nice to meet you’ in English” in a voice of a single target speaker. The controller 160 may obtain a pre-stored audio sample for the target speaker and may apply a speech synthesis model to the multilingual text and audio sample. The speech synthesis model may generate an audio signal that makes each word in the multilingual text sound as if it is spoken with the correct intonation of the corresponding language. In other words, the user may hear a voice that sounds like a selected target speaker speaking the multilingual text naturally.

In another example, the controller 160 may synthesize and convert the user's voice or text according to a different speaker and language.

According to another embodiment, the controller 160 and the communication module 150 may provide a speech synthesis function in conjunction with an electronic device located outside the vehicle 10.

FIG. 2 illustrates a speech synthesis according to an embodiment of the present disclosure.

Referring to FIG. 2, the speech synthesis system may include a vehicle 210 and an electronic device 220. The speech synthesis method may be implemented by the vehicle 210 and/or the electronic device 220. The speech synthesis model may be implemented on the electronic device 220, and the speech synthesis method may be performed by the electronic device 220.

The electronic device 220 may perform speech synthesis. The electronic device 220 may be implemented by at least one of a server device 221 or a mobile terminal 223.

The vehicle 210 may transmit a speech synthesis request to the electronic device 220, and the electronic device 220 may respond to the vehicle 210 with an audio signal, which is the speech synthesis result. The speech synthesis request may include text to be synthesized into a speech, language identifier for the text, and speaker information.

Specifically, the vehicle 210 may transmit a speech synthesis request, which includes a set comprising [text, speaker] or [text, speaker, language] to the electronic device 220. The electronic device 220 may generate an audio signal representing the requested text uttered by a desired speaker. Because the speaker does not actually read the text, the audio signal may represent generated data rather than a recorded signal. However, the audio signal may reproduce natural pronunciation and voice as if it were a recording of an actual speaker fluently speaking the requested text. The electronic device 220 may transmit the generated audio signal to the vehicle 210 as a speech synthesis result. The vehicle 210 may output an audio sound according to the requested text, a requested speaker, and a requested language to the user by playing the received audio signal.

Meanwhile, the electronic device 220 may include a processor and a memory for speech synthesis.

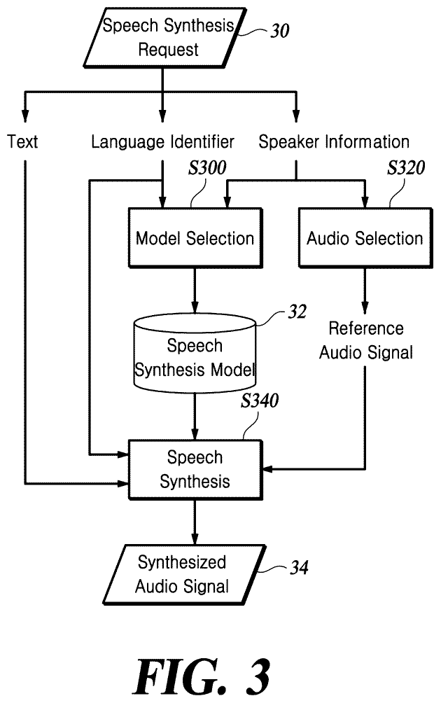

FIG. 3 illustrates the operation of a speech synthesis device according to one embodiment of the present disclosure.

Referring to FIG. 3, the speech synthesis device may receive text and a speech synthesis request including speaker information 30.

The speech synthesis device may obtain a language identifier corresponding to the text. The language identifier may include a number by which various languages may be uniquely identified. For example, the language identifier may have a value of 0 for English and a value of 1 for Korean. The language identifier may have the same length as the character strings corresponding to the content of utterances in the text. In some embodiments, the language identifier may be included in a speech synthesis request separately from the text. In other embodiments, information for identifying a language (e.g., a language code) may be combined within the text. The speech synthesis device may extract the language code from the text and may generate a language identifier based on the extracted language code. In yet another embodiment, the speech synthesis device may generate a language identifier by automatically detecting (or recognizing) the language of text from the text.

The speech synthesis request may be largely divided into three cases comprising intra-lingual synthesis, cross-lingual synthesis, and code-mixed synthesis. Intra-lingual synthesis may refer to synthesizing a speech that a speaker of a particular language utters in that language. For example, intra-lingual synthesis may include synthesizing a Korean speech by a Korean speaker. Cross-lingual synthesis may refer to synthesizing a speech that a speaker of a particular language utters in a different language. For example, cross-lingual synthesis may include synthesizing a Korean speech by an American speaker. Code-mixed synthesis may refer to synthesizing a speech that a speaker of a particular language utters in multiple languages. For example, code-mixed synthesis may include synthesizing a speech from multilingual text that includes Korean and English using the voice of a Korean speaker.

Table 1 shows examples of intra-lingual, cross-lingual, and code-mixed synthesis.

TABLE 1

| | | | Descrip- |
|---|---|---|---|
| No | Category | Value | tion |
| 1 | Text | “ [symbol] .” | Intra- |
| | Language | 111111 11 11 111 | lingual |
| | identifier | | synthesis |
| | Speaker | Korean speaker | |
| 2 | Text | “Please call Stella.” | Intra- |
| | Language | 000000 0000 000000 | lingual |
| | identifier | | synthesis |
| | Speaker | American speaker | |
| 3 | Text | “ [symbol] .” | Cross- |
| | Language | 111111 11 11 111 | lingual |
| | identifier | | synthesis |
| | Speaker | American speaker | |
| 4 | Text | “Please call Stella.” | Cross- |
| | Language | 000000 0000 000000 | lingual |
| | identifier | | synthesis |
| | Speaker | Korean speaker | |
| 5 | Text | “ [symbol] Bite the bullet [symbol] ?” | Code- |
| | Language | 11 1 0000 000 0000001 11 1111 | mixed |
| | identifier | | synthesis |
| | Speaker | Korean speaker | |

The speech synthesis device may identify the type of speech synthesis request based on speaker information and/or language identifier and may select a speech synthesis model 32 to be used to synthesize speech corresponding to the requested text based on the type of the speech synthesis request (S300). For example, the speech synthesis device may include all or part of a multispeaker-multilingual speech synthesis model, a multispeaker-monolingual speech synthesis model, and a single-speaker monolingual speech synthesis model. If the requested task includes cross-lingual synthesis or code-mixed synthesis, the speech synthesis device may select the multispeaker-multilingual speech synthesis model as the model to be used for inference.

The speech synthesis device may select a reference audio signal based on speaker information (S320). For example, the speech synthesis device may have one or more audio signals prepared in advance for each speaker. The speech synthesis device may randomly select a reference audio signal from among one or more audio signals for a target speaker indicated by the speaker information. As another example, the reference audio signal may be included in the speech synthesis request 30 as speaker information.

The speech synthesis device may apply the text, language identifier, and reference audio signal to the selected speech synthesis model 32 and thus may synthesize the speech of the target speaker uttering the text, who is indicated by the speaker information (S340).

The speech synthesis device may output the synthesized audio signal 34 as a response to the speech synthesis request 30.

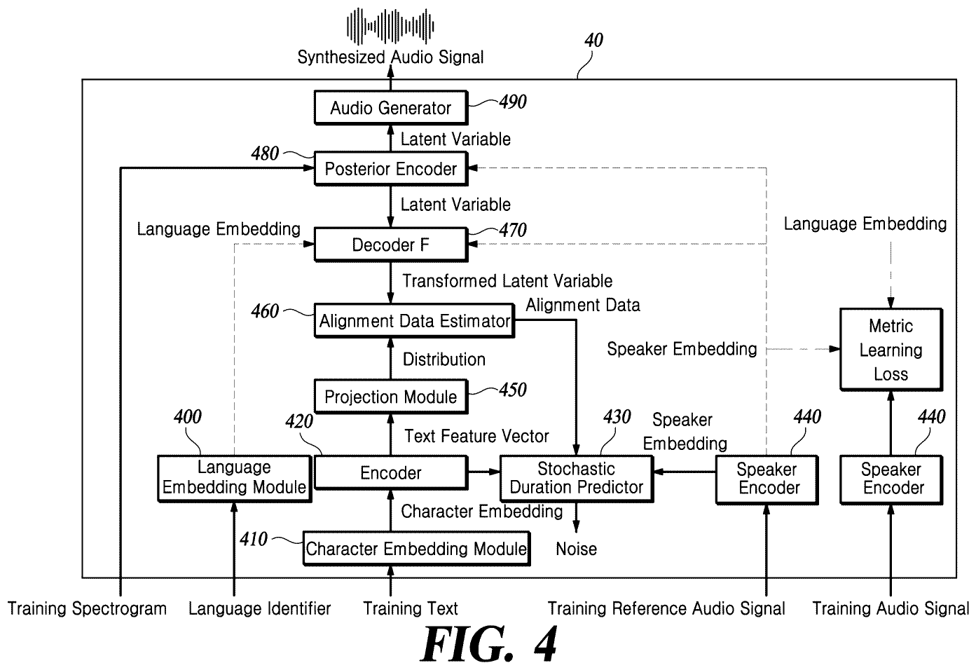

FIG. 4 illustrates training of a speech synthesis model according to an embodiment of the present disclosure.

Referring to FIG. 4, a model architecture 40 specifying the training stage of a speech synthesis model is shown. In the training stage, the model architecture 40 may include all or some of a language embedding model 400, character embedding model 410, an encoder 420, a stochastic duration predictor 440, a speaker encoder 440, a projection module 450, an alignment data estimator 460, a decoder 470, a posterior encoder 480, and an audio generator 490. In another embodiment, part of the constituting elements included in the model architecture 40 may be omitted, or the order of the constituting elements may be changed. The model architecture 40 may further include a discriminator. However, the discriminator is not shown in the figure. The posterior encoder 480 and the discriminator may be used only for the training of the speech synthesis model.

In FIG. 4, the dashed arrow may indicate global conditioning. In the present disclosure, conditioning of embeddings may refer to adding, multiplying, or subtracting embeddings to or from the input or within. To ensure dimensionality matching, the convolutional layer may adjust the dimension of the embeddings. For example, within the decoder 470, speaker embeddings may be incorporated into latent variables.

For training the speech synthesis model, a training dataset may be prepared in advance. The training dataset may include text data, audio data corresponding to the text data, and language data. The audio data may be a recording of text data actually spoken by one or more speakers.

The training data may comprise pairs of [training text, training audio signal]. The training text may include a sequence of characters in a natural language. For example, the sequence of characters may include alphabetic characters, numbers, punctuation marks, or other special characters. The training audio signal may represent speech data of speakers. The training audio signal may include voice characteristics and/or speech characteristics of a speaker. A speaker's speech characteristics may include at least one of various elements such as speech speed, pause intervals, pitch, tone, prosody, intonation, pronunciation, or emotion. In an embodiment, the training dataset may include audio signals of multiple speakers.

Furthermore, linear-spectrograms or Mel-spectrograms converted from the training audio signal may be prepared in advance to be used as training data. Linear-spectrograms may be generated by applying the short-time Fourier transform (STFT), discrete Fourier transform (DFT), or fast Fourier transform (FFT) to the audio signal. A Mel-spectrogram is obtained by adjusting the frequency interval of the linear-spectrogram to the Mel-scale. The Mel-spectrogram may be obtained by applying a Mel-filterbank to the linear spectrogram.

The training data may further include speaker information for identifying the speaker of the audio signal. Additionally or alternatively, the training data may further include a language identifier for identifying a language corresponding to the training text and the training audio signal. The language identifier may be represented as a number. For example, the language identifier may be a number that may uniquely identify one of various languages, such as Korean, English, German, Japanese, and Chinese. For example, English may have a value of 0, Korean may have a value of 1, and German may have a value of 2. In some embodiments, the language identifier may be assigned to each individual word or character in the training text. For example, if the training text consists of a single language, the language identifier may be generated by repeating the padding of a single language identifier to match the length of the training text.

Meanwhile, since most speakers may speak only a small number of languages, audio signals containing speech uttered by multiple speakers in various languages may be sparse. In other words, the multispeaker-multilingual datasets may be sparse.

To enable zero-shot speech synthesis for speech of an unseen speaker-language, the training data may further include a training reference audio signal obtained from the speaker of the training audio signal uttering reference text different from the training text. The training reference audio signal may be randomly selected from a plurality of audio signals prepared in advance for the speaker.

In some embodiments, all or some of the training reference audio signal, the training spectrogram, and/or the sequence of language identifiers may be added to the training dataset in the preprocessing stage of training, but the present disclosure is not limited to the specific embodiment.

Hereinafter, with reference to FIG. 4, the steps of processing the training text, the training audio signal, the training reference audio signal, the training spectrogram, and the language identifier within a training dataset for training are described.

The language embedding module 400 may transform the language identifier corresponding to training text into a language embedding. For example, the language embedding may correspond to a trainable embedding. In another example, the language embedding module 400 may map the language identifier to a language embedding using one-hot encoding. The language embedding may be in a vector form. Because one-hot encoding is a widely known technology in the field of speech synthesis, detailed descriptions thereof have been omitted.

The speaker encoder 340 may transform or map the speaker's training audio signal and training reference audio signal into the respective speaker embeddings. Speaker embeddings represent the speaker's speech characteristics and may be expressed in a vector form. Also, the speaker embedding may include speaker identification information. The speaker embedding may have the same dimensionality as the language embedding.

The speaker encoder 440 may represent discontinuous data values included in speaker information as a vector composed of consecutive numbers. For example, the speaker encoder 440 may generate a speaker embedding vector based on a combination of at least one or two or more of various artificial neural network models, including a pre-net, a CBHG module, a deep neural network (DNN), a convolutional neural network (CNN), a recurrent neural network (RNN), a long short-term memory network (LSTM), and a Bidirectional Recurrent Deep Neural Network (BRDNN).

The character embedding module 410 may transform or map training text into character embeddings. For example, training text may be composed in sentence or character units. The character embedding module 410 may separate the training text into character units and transform each separated text into character embeddings. Alternatively, the character embedding module 410 may separate the training text into alphabet units or phoneme units and then may transform them into character embeddings. For example, the text embedding module 410 may perform text embedding using an artificial neural network model. Character embeddings may be represented as learnable vectors.

The encoder 420 may extract text feature vectors from character embeddings. Text feature vectors extracted by the encoder 420 may include character embeddings, i.e., features of the training text.

In one embodiment, the encoder 420 may perform encoding in phoneme units. To this end, the encoder 420 may separate the character embeddings into phoneme units of the training text. In another embodiment, the encoder 420 may perform encoding on the entire set of character embeddings.

The encoder 420 may be an artificial neural network. For example, the encoder 420 may be a transform-based encoder 420. The transform-based encoder 420 includes a plurality of transformer blocks, and each transformer block includes at least one encoder 420, at least one decoder, and an attention module. For example, the transform-based encoder 420 may include 10 transformer blocks. The transformer block extracts context vectors from character embeddings using the encoder 420, identifies important character embeddings using the attention module, and generates text feature vectors from a context vector and the outputs of the attention module using the decoder 470.

The projection module 450 may output the distribution of text feature vectors to match dimensions. Here, the distribution of text feature vectors may be a prior distribution including the means and standard deviations of the text feature vectors. The distribution may include the mean and standard deviation of each text feature vector corresponding to each phoneme. The projection module 450 may be a linear projection layer.

The posterior encoder 480 may encode training spectrograms and may output latent variables. Encoding may mean extracting features from existing data and transforming them into data with reduced size or dimensionality compared to existing data. In other words, the result output through encoding may be the result obtained by compression of the input data. The latent variable may be a latent vector. Latent variables may include the speaker's voice and/or speech characteristics.

The training spectrograms may be linear-scale spectrograms or mel-spectrograms transformed from the speaker's training audio signal. In another embodiment, an audio file format such as wav or mp4 is input to the posterior encoder 480, and the posterior encoder 480 may encode the audio signal to extract a latent vector.

The posterior encoder 480 may further employ the speaker embedding to output latent variables. In other words, the posterior encoder 480 may receive the training spectrogram and speaker embedding and may extract latent variables from the training spectrogram and speaker embedding. Speaker embeddings may be used for global conditioning. For example, speaker embeddings may be added to the training spectrograms or latent variables. The conditioned latent variables include the features of the training spectrograms and speaker embeddings.

The posterior encoder 480 may be a deep neural network. For example, the posterior encoder 480 may be a Variational Auto-Encoder (VAE) encoder. The posterior encoder 480 may include non-causal WaveNet residual blocks used in the WaveGlow model and the Glow-TTS model. For example, the posterior encoder 480 may include 12 wavenet residual blocks. The non-causal WaveNet residual block consists of an extended convolutional layer with gated activation units and skip connections. A linear projection layer on top of the block generates the mean and variance of the normal posterior distribution.

The decoder 470 may output transformed latent variables based on the latent variables, language embeddings, and speaker embeddings. The decoder 470 may generate a latent variable having a distribution different from the prior distribution of the latent variable. Here, the different distribution may be a normal distribution.

The decoder 470 may use the speaker embeddings as conditioning information. For example, the decoder 470 may condition the speaker embeddings on the input or the output of the decoder 470 by adding or multiplying the speaker embeddings to the latent variables or the transformed latent variables.

Furthermore, the decoder 470 may remove language information from the latent variables. In an embodiment, the decoder 470 receives language embeddings corresponding to training text. The decoder 470 may remove language-related features within the latent variables by normalizing the language information of the latent variables.

As described above, the decoder 470 may condition the latent variables and the speaker embeddings, may normalize language-related features within the latent variables conditioned based on the language embeddings, and may generate the transformed latent variables by sampling the variables from a distribution simpler or more complex than the distribution of the preprocessed latent variable. Here, preprocessing refers to conditioning of speaker embeddings and normalization of language embeddings. The decoder 470 may remove language-specific characteristics of the training text in the conditioned latent variables by normalizing the latent variable conditioned by language embeddings. The language-specific characteristics may also be referred to as linguistic features or language information. The transformed latent variable includes features of training audio signals and may not include language-specific characteristics of the training text.

The decoder 470 may be a normalizing flow function. The decoder 470 may obtain a transformed latent variable by applying the function f to the preprocessed latent variable. Because the distribution transformation of the decoder 470 is reversible, an inverse function exists for the decoder f. The transformed latent variable may have the same, a different, or a more complex distribution compared to the original latent variable. Here, a complex distribution refers to the one with multiple local minima and maxima, unlike a simple normal distribution.

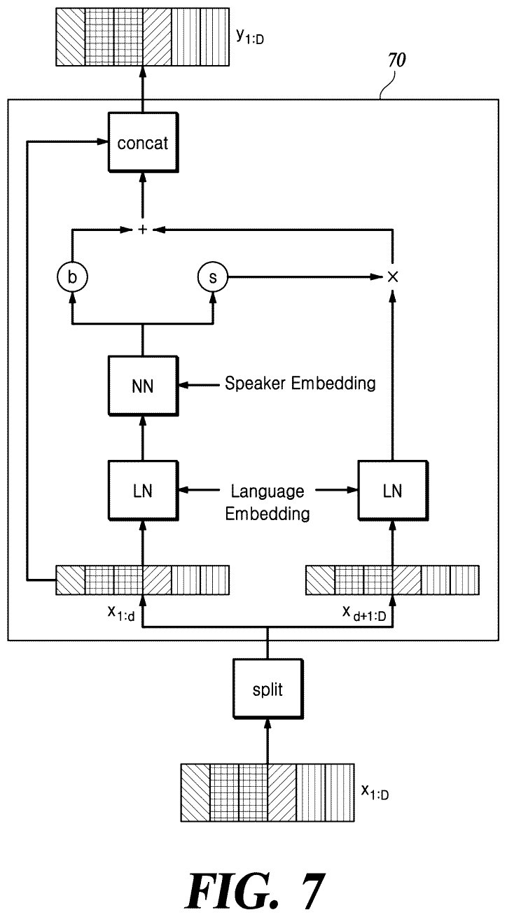

The decoder 470 may be a deep neural network. In particular, the decoder 470 may be a flow-based decoder. The decoder 470 may include a plurality of affine coupling layers. For example, the decoder 470 may include four affine coupling layers. At least a portion of the plurality of affine coupling layers may be used for the exclusion of the language-specific characteristics. The affine coupling layer for the exclusion of the language-specific characteristics may be referred to as a Language Normalized Affine Coupling Layer (LNAC). The transformation by a LNAC layer is described below with reference to FIG. 7.

In some embodiments, a speaker embedding may be additionally considered during the process of normalizing a language embedding. For example, the speaker embedding may be input to a neural network for generating scale parameters and/or bias parameters. In another example, at least a portion of affine coupling layers of the inverted decoder 680 may be used independently for the application of the speaker embedding.

By using a plurality of affine coupling layers, the decoder 470 may generate the transformed latent variable conditioned by the speaker embeddings and normalized by the language embeddings.

The alignment data estimator 460 may output alignment data based on the distribution of text feature vectors and transformed latent variables.

In an embodiment, the alignment data estimator 460 may estimate a matrix for sorting the duration of each phoneme of the training text based on the mean values, standard deviation values, and transformed latent variables of the text feature vectors as alignment data. The alignment data's dimensionality may depend on the length of the latent variable and the length of the character embedding. For example, rows may represent phonemes, while columns may represent time intervals. In the alignment data, the duration of each phoneme may be expressed in the form of a path; elements along the path may have a value of 1, while other elements may have a value of 0. In other words, alignment data may refer to alignment information between phonemes of training text and their respective latent variables.

To estimate matrix A, which is the alignment data between phonemes included in the training text, Monotonic Alignment Search (MAS), a method of searching for alignment that maximizes the likelihood of data parameterized by a flow normalization function, may be used. The alignment data estimator 460 may estimate alignment data by applying the MAS method to the distribution of text feature vectors and transformed latent variables. Because the MAS method is a widely known method, detailed descriptions thereof have been omitted.

The alignment data may be used to train the stochastic duration predictor 430. The alignment data may refer to the similarity between text feature vectors and the transformed latent variable.

The stochastic duration predictor 430 may receive text feature vectors, alignment data, and speaker embeddings and, based on the received input, may predict the duration of each phoneme in the training text. In other words, the stochastic duration predictor 430 may predict phoneme duration data.

The stochastic duration predictor 430 may use speaker embeddings as conditioning information. The stochastic duration predictor 430 may condition speaker embeddings during the calculation process. For example, speaker embeddings may be added or multiplied to text feature vectors or alignment data.

The stochastic duration predictor 430 may be a flow-based generative model trained through maximum likelihood estimation. Meanwhile, noise may be calculated during the process of predicting phoneme length data.

The audio generator 490 may generate a synthesized audio signal in the time domain based on latent variables. In other words, the audio generator 490 may generate a speech waveform based on the prior distribution of latent variables.

The audio generator 490 may be a deep neural network. The audio generator 490 may be a vocoder. For example, the audio generator 490 may be a HiFi-GAN generator. The audio generator 490 may comprise a stack of transposed convolutions, each convolution possibly followed by a multi-receptive field fusion (MRF) module. The output of MRF is a sum of the outputs of ‘residual blocks’ with varying receptive field sizes. The audio generator 490 may include a linear layer responsible for transforming speaker embeddings, may add the speaker embeddings to the latent variable z, and may generate an audio signal from the combination of the latent variable and the speaker embeddings.

The architecture 40 of the speech synthesis model may be trained by a training device implemented by a computer. In some embodiments, end-to-end training may be applied to the architecture 40 of the speech synthesis model, but the present disclosure is not limited to the specific training technique.

To reduce the dependency between the speaker embedding and the language embedding generated by the speech synthesis model, an intercross training technique may be applied and utilizes a training reference audio signal obtained from a speaker of a training audio signal uttering text different from the training text may be applied. The intercross training technique is intended to remove language-related information from the speaker embedding and to clearly separate the information contained in the speaker embedding from information in the language embedding.

Specifically, as a loss function for training the speech synthesis model, a metric learning loss using the distance measured between the embeddings may be used.

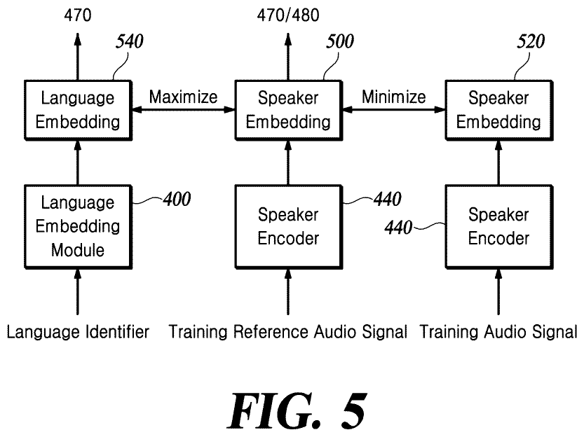

FIG. 5 illustrates a metric learning loss between speaker embedding and language embedding according to one embodiment of the present disclosure.

As described above, the speaker encoder 440 may transform a training reference audio signal and a training audio signal into the respective speaker embeddings 500 or 520, and the language embedding module 400 may transform the language identifier of the training text into a language embedding 540. At this time, the speaker embeddings 500 and 520 and the language embedding 540 may have the same dimensionality. This means that the embeddings 500, 520, and 540 may be embedded in the same feature space, and thus it is possible to calculate a distance between any two embeddings among the embeddings 500, 520, and 540.

To force the information of each speaker embedding 500 or 520 and the language embedding 540 not to overlap, a metric learning loss may be designed to maximize the distance between each speaker embedding 500 or 520, and the language embedding 540. Also, a metric learning loss may be designed to minimize the distance between the speaker embeddings 500 and 520 to force the speaker embeddings 500 and 520 to contain only information on the speaker identity but exclude information on the text.

In other words, contrastive learning may be applied to minimize the distance between the speaker embeddings 500 and 520 while maximizing the distance between each speaker embedding 500 or 520 and the language embeddings 540.

Meanwhile, cosine distance or Euclidean distances may be used as a distance metric for the metric learning loss. Here, in the case of cosine distance, even if the absolute distance between the embeddings is large, the distance may still be measured to be close if the features are similar. Therefore, for the purpose of independently processing information on the speaker and information on the language, it may be more appropriate to use the Euclidean distance rather than the cosine distance. Meanwhile, the metric learning loss based on the Euclidean distance may include the contrastive loss and the triplet loss. In the contrastive loss, the absolute distance between positive pairs and the absolute distance between negative pairs are measured, respectively. However, excessively increasing the distance between negative pairs may deteriorate the speech quality. On the other hand, because the triplet loss measures the relative distance between the anchor, a positive sample, and a negative sample, the triplet loss may prevent the resulting distances from becoming excessively large. Therefore, in an embodiment, the triplet loss may be used as the metric learning loss, which uses the speaker embeddings 500 and 520 and the language embedding 540 as the anchor, the positive sample, and the negative sample, respectively. When speaker embeddings 500 and 520 and language embedding 540 are denoted as

$${e}_{s}^{it} ,$$

eₛ, and eₗ, the triplet loss may be expressed by Eq. 1.

$${ℒ}_{triplet} ( {e}_{s} . {e}_{s}^{it} , {e}_{l} ) = {\sum }_{e} max ( 0 , {‖ {e}_{s}^{it} - {e}_{s} ‖}_{2}^{2} - {‖ {e}_{s}^{it} - {e}_{l} ‖}_{2}^{2} + ϵ ) \qquad [ Eq . 1 ]$$

In Eq. 1, ϵ represents a hyperparameter that determines the lower bound of the distance between a negative pair.

Meanwhile, in the inference step using the speech synthesis model, the speech synthesis model may generate a synthesized audio signal based on a reference audio signal that records the speech of a desired target speaker uttering text different from the input text (i.e., the speech content of a synthesized audio signal to be generated). In contrast, when a training audio signal is used to generate a synthesized audio signal during the training step, the amount of information the model references in the training and inference steps may be different. When the model trained in this manner synthesizes a speech of an unseen speaker-language, the quality of the generated speech may degrade, resulting in poor sound quality or unclear pronunciation.

Considering the issue above, the speech synthesis model may be designed to generate a synthesized audio signal based on a training reference audio signal rather than a training audio signal, during both the training step and the inference step. For example, a speaker embedding 500 transformed from a training reference audio signal may be input to the decoder 470 and/or the posterior encoder 480. Meanwhile, the speaker embedding 520 transformed from the training audio signal may be used only for a loss function and may not be directly used for generating a synthesized audio signal.

Meanwhile, it should be apparent to those having ordinary skill in the art that other loss functions may be further used for the training of the speech synthesis model.

For example, the loss function of the speech synthesis model may further use at least one of reconstruction loss, Kullback-Leibler Divergence loss, duration loss, adversarial loss, or feature matching loss.

The reconstruction loss may be calculated based on the difference between the spectrogram for the generated synthesized audio signal (or spectrogram thereof) and the training audio signal (or spectrogram thereof). A converter may be additionally used to convert the generated synthesized audio signal into a spectrogram.

The KL divergence loss may be calculated based on the difference between the latent variable and the text feature vectors. The KL divergence loss may be calculated based on the difference between the posterior probability of the latent variable and the conditional prior probability for the text feature vector. In other words, KL divergence loss may refer to the similarity between the distribution of the latent variable and the distribution of the text feature vector.

The duration loss may be calculated based on the difference between the phoneme duration data predicted by the stochastic duration predictor 430 and the duration of the phoneme generated by the alignment data estimator 360. In another example, the utterance duration of each phoneme in the audio sample actually recorded by the speaker may be prepared in advance as a label for calculating the duration loss. The duration loss may be calculated through the mean square error (MSE). The duration loss is intended to enable the stochastic duration predictor 430 to predict the duration of each phoneme uttered by a conditioned speaker. The duration loss may be referred to as a variance lower bound for the log likelihood of a phoneme sequence.

The adversarial loss may be calculated based on the discriminator's determination on whether a synthesized audio signal generated by the audio generator 490 is real. To this end, the discriminator that is trained to distinguish whether the input audio signal is real or fake may be used. The discriminator may be, for example, a HiFi-Discriminator. To reduce the adversarial loss, it is necessary for the discriminator to determine the generated synthesized audio signal as real data. The adversarial loss causes the discriminator to output a value of 1 in response to an input of real data and to output a value of 0 in response to an input of fake data.

Meanwhile, the feature matching loss is calculated based on the difference between features extracted by the discriminator from the generated audio signal and features extracted by the discriminator from the real audio signal.

Through training based on the adversarial loss and feature matching loss, the audio generator 490 may generate audio signals almost identical to real data.

Optionally, the loss function of the model architecture 40 may further include speaker consistency loss (SCL). Speaker consistency loss may be calculated based on the difference between the output of the speaker encoder 440 and the ground-truth.

The model architecture 40 may be updated in the direction that decreases the loss function above. Through iterative training based on the overall loss function, each component of the model architecture 40 is refined, enabling the speech synthesis model to generate natural speech signals of the speaker.

Through the training process described above, the speech synthesis model may become robust to linguistic diversity. A speaker's dependency on a specific language is reduced. In other words, the speech synthesis model is trained based on text and speakers rather than specific languages. However, during the inference stage, the speech synthesis model utilizes linguistic information. Even if the speech synthesis model receives text in an unseen language, the speech synthesis model may generate a speaker's natural speech from the text using the information on the unseen language. For example, even if the training dataset is primarily composed of [Korean text, Korean voice] pairs with little instances of [Korean text, American voice] pairs, the speech synthesis model learns the meaning of the Korean text and captures speech characteristics of Americans without linguistic information. Afterwards, during the inference stage, the speech synthesis model may synthesize natural speech by incorporating Korean embeddings into [Korean text, American voice] data.

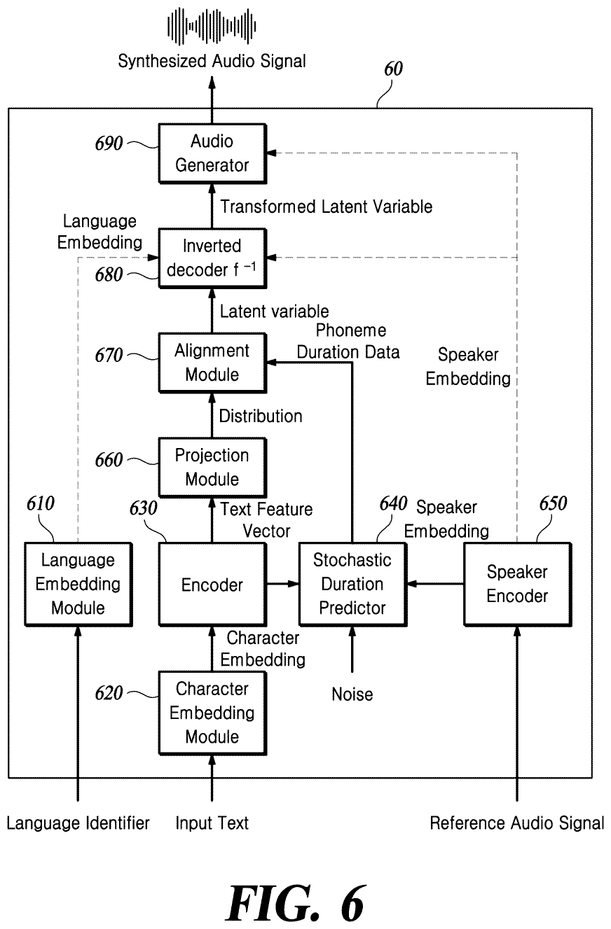

FIG. 6 illustrates the operation of a speech synthesis model according to an embodiment of the present disclosure.

Referring to FIG. 6, the configurations of the speech synthesis model 60 are shown. The speech synthesis model 60 may generate an audio signal as if the input text in a given language were spoken by a specific speaker. For example, the speech synthesis device stores language identifier set by the user and pre-recorded audio samples of a selected speaker. The content of the audio samples may differ from that of the input text. The speech synthesis device may synthesize an audio signal by applying the speech synthesis model to language identifier, the speaker's audio signals, and the target text.

In the inference stage, the speech synthesis model 60 includes a language embedding module 610, a character embedding module 620, an encoder 630, a stochastic duration predictor 640, a speaker encoder 650, and a projection module 660, an alignment module 670, an inverted decoder 680, and an audio generator 690.

The speech synthesis model 60 may have been trained by the method of FIG. 4. For example, the language embedding module 610, character embedding module 620, encoder 630, stochastic duration predictor 640, speaker encoder 650, projection module 660, inverted decoder 680, and audio generator 690 of FIG. 6 correspond to the language embedding module 400, character embedding module 410, encoder 420, stochastic duration predictor 430, speaker encoder 440, projection module 450, decoder 470, and audio generator 490 of FIG. 4. The inverted decoder 680 may represent the inverse function of the decoder 470.

The language embedding module 610 may convert the language identifier of input text into language embeddings. In another embodiment, the language embedding module 610 may be omitted, and language embeddings corresponding to various languages may be stored in advance. In other words, language embeddings corresponding to the language identifier of the input text are pre-stored, and the inverted decoder 680 may receive the language embeddings. In some examples, the input text may include words or characters corresponding to multiple languages. The language embedding module 610 may generate language embedding for each word or for each character.

The character embedding module 620 may convert given input text into character embeddings. The input text may be mapped to a variable space for character embeddings.

The encoder 630 may output text feature vectors for the input text by encoding character embeddings. Text feature vectors may include features of each phoneme of the input text.

The speaker encoder 650 receives a reference audio signal recording the voice of a selected target speaker and outputs speaker embeddings by encoding the reference audio signal. Speaker embeddings may include the speaker's voice and/or speech characteristics. The speaker encoder 650 may generate speaker embeddings of the same dimensions as language embeddings.

The stochastic duration predictor 640 may predict the duration of each phoneme of the input text based on text feature vectors and speaker embeddings and may output phoneme duration data including the duration of the phonemes. The phoneme duration data includes predicted duration for each phoneme based on the speaker's voice and/or speech characteristics. The phoneme duration data may be converted into an integer and input to the alignment module 670. For example, a ceiling function may be applied to the duration of each phoneme predicted by the stochastic duration predictor 640, but is not limited thereto.

The projection module 660 may generate the distribution of text feature vectors. The distribution of text feature vectors may include means and standard deviations of the text feature vectors. In this process, the text feature vector may be transformed to match the dimensionality of the alignment data of the alignment module 670. The dimensionality of data representing the distribution may correspond to one of the dimensions of the alignment data.

The alignment module 670 may generate latent variables based on the distribution of text feature vectors and phoneme duration data. Latent variables may be generated from text feature vectors based on the phoneme duration data. For example, the alignment module 670 may calculate the mean and standard deviation of text feature vectors corresponding to each phoneme using the alignment data and output latent variables as a result of calculation. Latent variables may include features of each phoneme of the input text and features related to the duration of each phoneme.

The inverted decoder 680 may generate transformed latent variables based on the latent variables, language embeddings, and speaker embeddings. The inverted decoder 680 may condition the language embeddings and the speaker embeddings on the latent variable and thus may transform the latent variable into a variable having a prior distribution different from that of the original latent variable. In the conditioning process, language embeddings and speaker embeddings may be added or multiplied to latent variables.

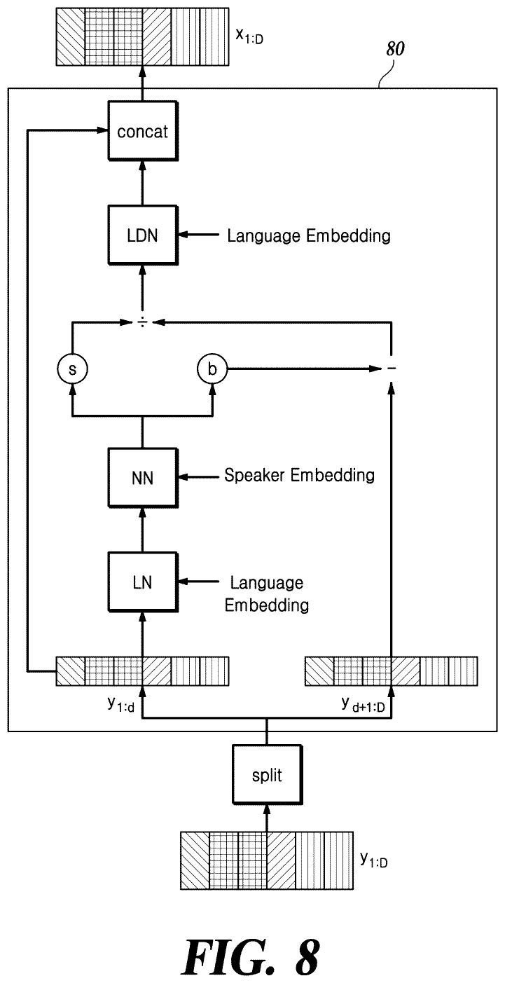

Because the inverted decoder 680 is trained for language normalization to exclude language-related features during the training stage, language embeddings have to be incorporated into the latent variables during the inference stage. To this end, at least some of the affine coupling layers in the inverted decoder 680 are used for denormalization of language embeddings. As such, the affine coupling layer used for denormalization may be referred to as a Language Denormalized Affine Coupling layer. By denormalizing the language embedding, features of the language embedding may be reflected in the latent variable or the latent variable conditioned on the speaker embedding. The transformation by the language denormalized affine coupling layer, i.e., the inverse transformation of the normalized affine coupling layer, is described below with reference to FIG. 8.

In some embodiments, the speaker embedding may be additionally considered during the process of denormalizing the language embedding. For example, the speaker embedding may be input to a neural network for generating scale parameters and/or bias parameters. In another embodiment, at least a portion of affine coupling layers of the inverted decoder 680 may be independently used for the application of the speaker embedding. The affine coupling layers may apply the speaker embedding as conditioning information for the latent variable or the intermediate calculation of the latent variable. For example, the speaker embedding may be added to or multiplied by the latent variable.

The inverted decoder 680 may transform the latent variables conditioned by the language embeddings and speaker embeddings. The inverted decoder 680 may obtain a transformed latent variable by applying the inverse function f⁻¹ of a normalizing flow function used in the training stage to the latent variable. The transformed latent variable may have a simpler or more complex distribution than the conditioned latent variable. The inverted decoder 680 may transform the distribution of the latent variable based on the speaker embeddings and language embeddings. The transformed latent variable includes features of the input text, features of language identifier, features of the target speaker's reference audio signals, and features of duration.

The audio generator 690 may generate an audio signal representing a sound wave from the transformed latent variable and speaker embeddings. The speaker embeddings may be incorporated into the transformed latent variables by conditioning. The audio generator 690 may generate an audio signal from the latent variables conditioned by the speaker embeddings. Specifically, the audio generator 690 may predict the audio signal from the distribution of the conditioned latent variables. The generated audio signal may be identical or similar to the audio recording of the target speaker uttering the input text. Even if the target speaker is unfamiliar with the language of the input text, a result may be generated as if the target speaker has uttered the input text in that language. Furthermore, even if several languages are included in the input text, a natural voice may be generated.

FIG. 7 illustrates one example of a language normalized affine coupling layer according to one embodiment of the present disclosure. FIG. 8 illustrates one example of a language denormalized affine coupling layer according to one embodiment of the present disclosure.

Language normalization (LN) for removing language information from the latent variable and language denormalization (LDN) for reflecting language information in the latent variable may be defined by Eqs. 2 and 3, respectively.

$$\begin{matrix}LN ( x ; {e}_{l} ) = \frac{x - {m}_{θ} ( {e}_{l} )}{exp ( {v}_{θ} ( {e}_{l} ) )} & [ Eq . 2 ] \\ LDN ( x ; {e}_{l} ) = x ⊙ exp ( {v}_{θ} ( {e}_{l} ) ) + {m}_{θ} ( {e}_{l} ) & [ Eq . 3 ]\end{matrix}$$

Here, x may represent a latent variable (or a latent variable conditioned on a speaker embedding), which is a conditioning target. eₗ represents a language embedding, and m_{θ}(⋅) and v_{θ}(⋅) represent linear projections of the language embedding to generate mean and variance parameters.

Language normalization may remove language information from a latent variable by subtracting the mean of the language embedding from the latent variable and dividing the result by the variance of the language embedding. On the other hand, language denormalization may reflect language information into a latent variable by adding the mean of the language embedding to the result of multiplying the latent variable by the variance of the language embedding.

Language normalization and language denormalization may be applied to a portion of dimensions of the input latent variable.

For example, referring to FIG. 7, the language normalized affine coupling layer 70 may generate an output latent variable by applying language normalization to a portion of dimensions of an input latent variable, applying the affine transformation to the normalization result based on scale and bias parameters, and combining the transformation result with a language normalization result for the remaining dimensions of the input latent variable. The forward transformation of the language normalized affine coupling layer 70 may be expressed by Eq. 4.

$${y}_{1 : d} = {x}_{1 : d} \\ {y}_{d + 1 : D} = LN ( {x}_{d + 1 : D} ; {e}_{l} ) ⊙ exp ( {s}_{θ} ( LN ( {x}_{1 : d} ; {e}_{l} ) ; {e}_{s}^{it} ) ) + {b}_{θ} ( LN ( {x}_{1 : d} ; {e}_{l} ) ; {e}_{s}^{it} ) \qquad [ Eq . 4 ]$$

In Eq. 4, x and y represent an input latent variable and an output latent variable with D dimensions, and s_{θ}(⋅) and b_{θ}(⋅) represent functions for generating scale and bias parameters. For example, s_{θ}(⋅) and b_{θ}(⋅) may be implemented using a neural network.

The affine coupling layer is easily invertible and has a triangular Jacobian matrix. The determinant may be calculated based on the Jacobin expression, from which the model density q may be easily calculated. For example, the inverse transformation of the affine coupling layer 70, i.e., the language denormalized affine coupling layer 80 may be expressed by FIG. 8 and Eq. 5.

$${x}_{1 : d} = {y}_{1 : d} \\ {x}_{d + 1 : D} = LDN ( \frac{{y}_{d + 1 : D} - {b}_{θ} ( LN ( {y}_{1 : d} ; {e}_{l} ) ; {e}_{s}^{it} )}{exp ( {s}_{θ} ( LN ( {y}_{1 : d} ; {e}_{l} ) ; {e}_{s}^{it} ) )} ; {e}_{s}^{it} ) \qquad [ Eq . 5 ]$$

Finally, the log-determinant for a conditional flow may be expressed by Eq. 6.

$$log \vert det \frac{\partial {f}_{θ} ( x )}{\partial x} \vert = log {\sum }_{j} \frac{exp ( {s}_{θ} ( LN ( {y}_{1 : d} ; {e}_{l} ) ; {e}_{s}^{it} ) )}{exp ( {{v}_{θ} ( {e}_{l} )}_{j} )} \qquad [ Eq . 6 ]$$

Here, f_{θ}(⋅) represents a bijective function for transformation of the latent variable.

In what follows, an experimental result of implementing the speech synthesis model is described with reference to Tables 2 to 4.

Table 2 shows speech synthesis models according to various embodiments and performance comparisons of the speech synthesis models (MSVITS and SANE-TTS) according to comparative examples.

TABLE 2

| | | Intra-lingual | | Cross-lingual | |
|---|---|---|---|---|---|
| Method | | MOS (CI) | SECS | MOS | SECS |
| Ground truth | | 4.63 | 0.6062 | | |
| | | (±0.01) | | | |
| MSVITS | | 3.40 | 0.5261 | 2.70 | 0.3792 |
| | | (±0.06) | | (±0.09) | |
| SANE-TTS | | 3.65 | 0.5396 | 3.51 | 0.3875 |
| | | (±0.03) | | (±0.02) | |
| Ours | (i) | 3.46 | 0.5594 | 3.73 | 0.4126 |
| | | (±0.04) | | (±0.05) | |
| | (ii) | 3.81 | 0.4052 | 2.78 | 0.3021 |
| | | (±0.03) | | (±0.09) | |
| | (iii) | 3.13 | 0.4188 | 2.50 | 0.2969 |
| | | (±0.06) | | (±0.11) | |

In the present experiment, for intra-lingual synthesis, a Korean speech is synthesized using Korean reference speeches and an English speech is synthesized using English reference speeches. For cross-lingual synthesis, an English speech is synthesized using Korean reference speeches, and a Korean speech is synthesized using English reference speeches. Meanwhile, the mean opinion score (MOS) and the speaker encoder cosine similarity (SECS) are used as the performance index.

In Table 2, (i) shows the performance when both contrastive learning and language-normalized affine coupling layers are applied, (ii) shows the performance when contrastive learning is omitted, and (iii) shows the performance when both contrastive learning and language-normalized affine coupling layers are omitted. Table 2 confirms that the model employing both contrastive learning and language-normalized affine coupling layers has the highest score in the cross-lingual synthesis environment.

Table 3 shows a comparison of the performance of speech synthesis for the models (i) to (iii). In the present experiment, word error rates (WER) and character error rates (CER) are used as the performance evaluation index.

TABLE 3

| | Error rate | KO2KO | EN2EN | KO2EN | EN2KO |
|---|---|---|---|---|---|
| (i) | WER | 13.7 | 10.3 | 14.7 | 15.3 |
| | CER | 3.7 | 5.2 | 8.4 | 3.7 |
| (ii) | WER | 13.8 | 9.3 | 17.5 | 16.1 |
| | CER | 3.6 | 4.8 | 10.2 | 3.9 |
| (iii) | WER | 12.8 | 10.0 | 27.6 | 16.5 |
| | CER | 2.9 | 4.9 | 22.1 | 4.1 |

As shown in Table 4, it may be confirmed that the model employing both the contrastive learning and language normalized affine coupling layers exhibits the lowest error rate for cross-lingual synthesis environments (KO2EN and EN2KO).

Table 4 shows a comparison result of cross-lingual speech synthesis performance due to the type of metric learning less used for contrastive learning. In the present experiment, cosine distance, contrastive loss, and triplet loss are used as the metric learning loss, and WER and CER are used as the performance evaluation index.

TABLE 4

| | Error | Cosine | Contrastive | Triplet |
|---|---|---|---|---|
| | rate | distance | loss | loss |
| KO2EN | WER | 29.3 | 21.6 | 14.7 |
| | CER | 21.5 | 14.7 | 8.4 |
| EN2KO | WER | 19.2 | 16.2 | 15.3 |
| | CER | 6.5 | 5.1 | 3.7 |

As shown in Table 4, it may be confirmed that the lowest error rate is obtained when the triplet loss is employed as the metric learning loss.

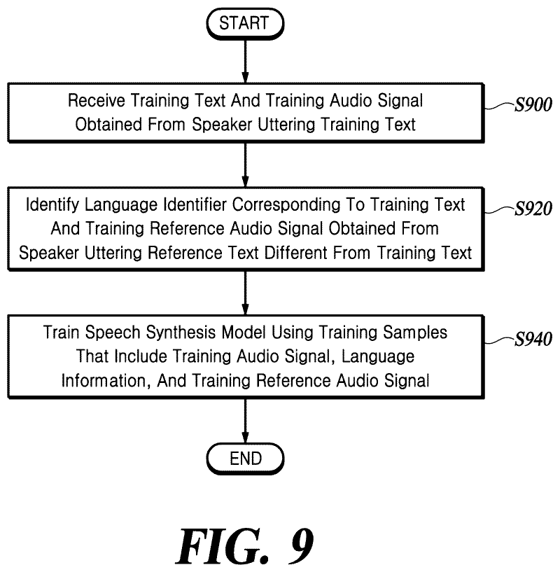

FIG. 9 is a flow diagram illustrating a method for training a speech synthesis model according to one embodiment of the present disclosure.

The training device receives training text and a training audio signal obtained from a predetermined speaker uttering the training text (S900). The training text may include a sequence of one or more characters.

The training device identifies a language identifier corresponding to the training text and a training reference audio signal obtained from a speaker uttering reference text different from the training text (S920). In some embodiments, the language identifier may include a sequence of identifiers corresponding to individual characters within the training text. The language identifier may be prepared in advance for the individual training text or generated in real-time by the training device. In some embodiments, a plurality of audio signals may be prepared in advance for the speaker. The training device may identify one or more audio signals other than the training audio signal among the plurality of audio signals and randomly select the training reference audio signal among the identified one or more audio signals.

The training device trains the speech synthesis model using training samples that include training text, training audio signals, language identifiers, and training reference audio signals (S940).

The speech synthesis model may include a language embedding module and/or a speaker encoder. The language embedding module may receive a language identifier as input and transform the received language identifier into a language embedding. The speaker encoder may separately receive the training audio signal and the training reference audio signal and transform them into speaker embeddings. The training device may determine a loss based on a first speaker embedding transformed from the training reference audio signal, a second speaker embedding transformed from the training audio signal, and the language embedding. The training device may update the parameters of the speaker encoder using the determined loss.

In some embodiments, the speaker encoder may be trained to generate the speaker embeddings independent of language-specific characteristics of the training audio signal and the raining reference audio signal. For example, the speaker encoder may be trained to embed the training audio signal and the training reference audio signal into a feature space in which the language embedding is embedded. Additionally or alternatively, the speaker encoder may be trained to place the first speaker embedding and the second speaker embedding close to each other in the corresponding feature space. Additionally or alternatively, the speaker encoder may be trained to place the first speaker embedding and the language embedding far apart. A loss for this be referred to as contrastive intercross loss or metric learning loss. The loss may include the triplet loss which uses, for example, the first speaker embedding, the second speaker embedding, and language embedding as an anchor, a positive sample, and a negative sample, respectively. In some embodiments, the contrastive intercross loss or the metric learning loss may constitute a portion of terms of a total loss for training of the speech synthesis model. The training device may update at least some of the speech synthesis model using the total loss.

In the training phase, the speech synthesis model may further include a posterior encoder, a decoder, a character embedding module, an encoder, a projection module, an alignment data estimator, a stochastic duration predictor, and/or an audio generator.

The posterior encoder may encode a spectrogram of the training audio signal into a latent variable.

The decoder may output a transformed latent variable based on the latent variable, the language embedding, and the first speaker embedding. The decoder may be trained to remove language-specific characteristics of the training audio signal by normalizing the latent variable based on the language embedding.

The character embedding module may transform the training text into character embeddings.

The encoder may encode the character embeddings into text feature vectors.

The projection module may output a distribution of the text feature vectors, wherein the distribution may include a mean and/or a standard deviation.

The alignment data estimator may estimate the alignment data based on the distribution of the text feature vectors and the transformed latent variable.

The stochastic duration predictor may be trained to predict a duration associated with the speaker's speech characteristics for each phoneme of the training text. The stochastic duration predictor may be trained based on the first speaker embedding, the text feature vectors, and the alignment data.

The audio generator may generate a synthesized audio signal corresponding to the training text from the latent variable.

The total loss for training the speech synthesis model may further include the reconstruction loss between the training audio signal and the synthesized audio signal, the KL divergence loss calculated based on text feature vectors and a latent variable (or transformed latent variable), the duration loss calculated based on the phoneme duration predicted by the stochastic duration predictor and the phoneme duration generated by the alignment data estimator, the adversarial loss for the audio generator, and/or the feature matching loss between the real audio signal and the synthesized audio signal.

As described above, the language embedding and the first speaker embedding may be provided as input to the sub-networks (e.g., the posterior encoder, the decoder, and/or the stochastic duration predictor) subsequent to the language embedding module and the speaker encoder in order to generate a synthesized audio signal corresponding to the training text. On the other hand, the second speaker embedding may be used only for the loss calculation and may not be directly used for generating the synthesized audio signal.

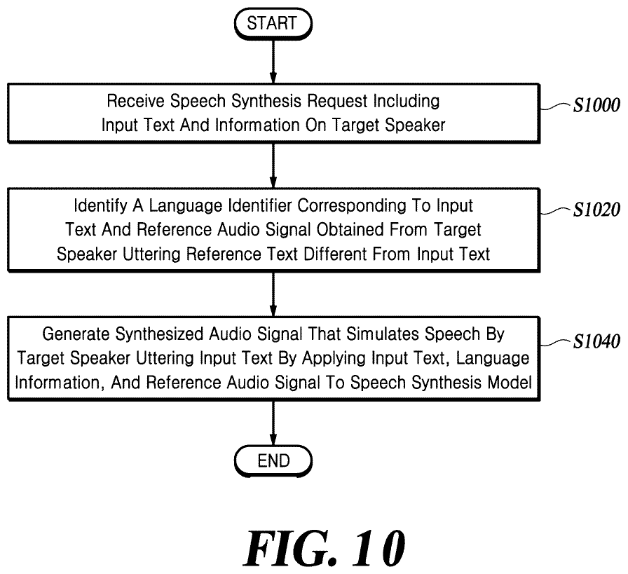

FIG. 10 is a flow diagram illustrating a speech synthesis method according to one embodiment of the present disclosure.

The speech synthesis device may receive a speech synthesis request including input text and information on the target speaker (S1000). The input text may include a sequence of one or more characters.

The speech synthesis device may identify a language identifier corresponding to the input text and a reference audio signal obtained from the target speaker uttering reference text different from the input text (S1020). The language identifier may include a sequence of language identifiers corresponding to individual characters within the training text. The speech synthesis request may further include a language identifier. For example, the speech synthesis device may identify the language identifier from the speech synthesis request. Additionally or alternatively, the speech synthesis device may directly recognize (or detect) the language identifier from the received input text. The reference audio signal may be included in the speech synthesis request as information on the target speaker. For example, the speech synthesis device may identify the reference audio signal from the speech synthesis request. Additionally or alternatively, audio signals obtained from a plurality of speakers may be stored in advance in the speech synthesis device and/or an external data storage that may be linked to the speech synthesis device. For example, the speech synthesis device receives an identifier uniquely assigned to the target speaker as information on the target speaker and may identify a reference audio signal for the target speaker among pre-stored audio signals using the received identifier.

The speech synthesis device generates a synthesized audio signal that simulates speech by the target speaker uttering the input text, by applying the input text, the language identifier, and the reference audio signal to a speech synthesis model (S1040).

The speech synthesis model may include the language embedding module and/or the speaker encoder. The language embedding module may receive the language identifier and transform the received language identifier into a target language embedding. The speaker encoder may receive the reference audio signal and transform the received reference audio signal into a target speaker embedding.

The speech synthesis model may have been trained by the process (or operations) described in FIG. 4 or FIG. 9. For example, the speaker encoder may be trained using a loss determined based on speaker embeddings for transformed from a plurality of training audio signals and a language embedding transformed from training text corresponding to one of the plurality of training audio signals. The plurality of training audio signals may be obtained from a common speaker. The speaker encoder may have been trained to generate speaker embeddings that are independent of language-specific characteristics of the training audio signals. The plurality of training audio signals may include a first training audio signal obtained from a specific speaker uttering text different from the training text and a second training audio signal obtained from the same speaker uttering the training text. The speaker encoder may have been trained to embed the first training audio signal and the second training audio signal into the same feature space as a language embedding transformed from the training text. The speaker encoder may have been trained to place a first speaker embedding transformed from the first training audio signal and a second speaker embedding transformed from the second training audio signal close to each other in the feature space. Additionally or alternatively, the speaker encoder may have been trained to place the first speaker embedding and the language embedding far apart.

The speech synthesis model may further include a character embedding module, an encoder, a stochastic duration predictor, a projection module, an alignment unit, an inverted decoder, and/or an audio generator.

The character embedding module may transform the input text into character embeddings.

The encoder may encode character embeddings into text feature vectors.

The stochastic duration predictor may predict the duration for each phoneme of input text. The stochastic duration predictor may predict, based on the text feature vectors and the target speaker embedding, the duration associated with the target speaker's speech characteristics. For example, even with the same phoneme, different durations may be predicted depending on the speaker.

The projection module may output the distribution of text feature vectors. The distribution may include the mean and the standard deviation.

The alignment unit may generate a latent variable based on the distribution of the text feature vectors and the duration predicted for each phoneme.

The inverted decoder may output a transformed latent variable based on the latent variable, the target speaker embedding, and the target language embedding. Specifically, the inverted decoder may condition the latent variable on the target speaker embedding and the target language embedding and output the transformed latent variable based on the conditioned latent variable.

The audio generator may generate an audio signal from the transformed latent variable. The audio generator may condition the transformed latent variable on the target speaker embedding and generate an audio signal from the conditioned transformed latent variable.

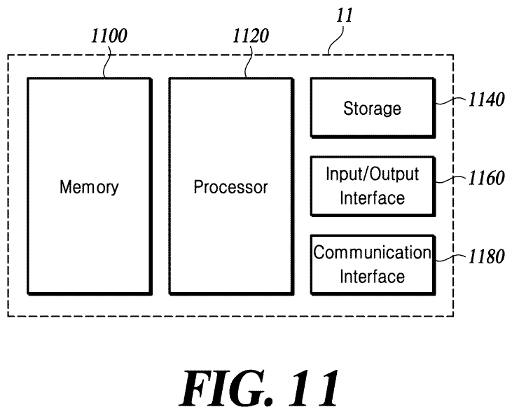

FIG. 11 is a schematic diagram of an illustrative configuration of a computing device that may be used to implement the apparatuses and methods described herein.

A computing device 11 may include some or all of a memory 1100, a processor 1120, a storage 1140, an input and output (I/O) interface 1160, and a communication interface 1180. The computing device 11 may structurally and/or functionally include at least a portion of the speech synthesis device or the training device. The computing device 11 may be a stationary computing device such as a desktop computer, a server, or an AI accelerator, or a mobile computing device such as a laptop computer or a smart phone. The computing device 11 may include any specialized hardware accelerator capable of efficiently processing computations on AI models. For example, the computing device 11 may include a graphic processing unit (GPU), a tensor processing unit (TPU), or a neural processing unit (NPU).

The memory 1100 may store a program that allows the processor 1120 to perform methods or operations according to various embodiments of the present disclosure. For example, the program may include a plurality of instructions executable by the processor 1120 and the plurality of instructions may be executed by the processor 1120 to perform the methods or operations described above. The memory 1100 may be a single memory or a plurality of memories. In this case, information required to perform methods or operations according to various embodiments of the present disclosure may be stored in the single memory or divided and stored in the plurality of memories. When the memory 1100 comprises the plurality of memories, the plurality of memories may be physically separated. The memory 1100 may include at least one of a volatile memory or a non-volatile memory. The volatile memory includes a static random access memory (SRAM), a dynamic random access memory (DRAM), or the like, and the non-volatile memory includes a flash memory.

The processor 1120 may include at least one core capable of executing at least one instruction. The processor 1120 may execute instructions stored in the memory 1100. The processor 1120 may be a single processor or a plurality of processors.

The storage 1140 maintains stored data even when power supplied to the computing device 11 is cut off. For example, the storage 1140 may include a non-volatile memory or may include a storage medium such as a magnetic tape, optical disc, or magnetic disk. A program stored in the storage 1140 may be loaded into the memory 1100 before being executed by the processor 1120. The storage 1140 may store files created in a program language, and a program created from a file by a compiler or the like may be loaded into the memory 1100. The storage 1140 may store data to be processed by the processor 1120 and/or data processed by the processor 1120.

The I/O interface 1160 may provide an interface with an input device, such as a keyboard or mouse, and/or an output device such as a display device or printer. A user can trigger execution of a program in the processor 1120 through the input device and/or check a processing result of the processor 1120 through the output device.

The communication interface 1180 may provide access to an external network. For example, the computing device 11 may communicate with another device (for example, the vehicle or the speech synthesis device) via the communication interface 1180.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in the present disclosure as being sequentially performed, this is merely an illustrative description of the technical idea of the present disclosure. In other words, those having ordinary skill in the art to which the present disclosure pertains should appreciate that various modifications and changes can be made without departing from essential features of the present disclosure. For example, the sequence illustrated in the flowcharts/timing charts can be changed and one or more operations of the operations can be performed in parallel. Thus, flowcharts/timing charts are not limited to the temporal order.

According to embodiments of the present disclosure, natural speech may be synthesized that gives an impression that a target speaker fluently speaks text in a target language even if audio data of the target speaker in the target language is sparse or absent.

According to one embodiment of the present disclosure, by using an intercross training technique and contrastive learning in the training stage of a speech synthesis model, the speech synthesis model may be controlled to separate information among input factors without being overfitted to the input factors.

According to one embodiment of the present disclosure, by separating and explicitly controlling speaker-related features and language-related features present in a speech signal, pronunciation clarity and sound quality of a synthesized speech may be improved in a cross-lingual synthesis or code-mixed synthesis case. For example, even if text to be synthesized includes words from multiple languages, a speech may be generated, which pronounces each word with a correct intonation of the corresponding language.

According to one embodiment of the present disclosure, by utilizing normalization and denormalization based on language embedding in the training and inference stages of a speech synthesis model, linguistic features may be effectively learned.

According to one embodiment of the present disclosure, multilingual and multispeaker speech synthesis may be achieved without involving complex fine-tuning. In other words, because no additional fine-tuning process is required after training, the overall learning time and cost may be reduced. Furthermore, because no separate module is required, the size of the speech synthesis model does not increase. As a result, the speech synthesis according to the present disclosure may be widely used in various application environments that may use only limited memory resources, such as vehicle environments.

According to one embodiment of the present disclosure, a vehicle passenger may be provided with a voice guidance synthesized with the passenger's desired speaker's voice and language.

The features of the present disclosure are not limited to the features described above. Other features not mentioned herein may be understood by those having ordinary skill in the art to which the present disclosure pertains from the description above.

Although embodiments of the present disclosure have been described for illustrative purposes, those having ordinary skill in the art should appreciate that various modifications, additions, and substitutions are possible, without departing from the idea and scope of the present disclosure. Therefore, embodiments of the present disclosure have been described for the sake of brevity and clarity. The scope of the technical idea of the present disclosure is not limited by the illustrations. Accordingly, one of ordinary skill in the art should understand that the scope of the present disclosure is not limited by the above explicitly described embodiments but by the appended claims and equivalents thereof.

What is claimed is:

1. A method comprising:
receiving training text and a training audio signal obtained from a speaker uttering the training text;
identifying a language identifier corresponding to the training text and a training reference audio signal obtained from the speaker uttering reference text different from the training text; and
training a speech synthesis model using training samples that include the training text, the training audio signal, the language identifier, and the training reference audio signal,
wherein training the speech synthesis model includes:
transforming, by a language embedding module of the speech synthesis model, the language identifier into a language embedding;
transforming, by a speaker encoder of the speech synthesis model, the training audio signal and the training reference audio signal into speaker embeddings; and
determining a loss based on a first speaker embedding transformed from the training reference audio signal, a second speaker embedding transformed from the training audio signal, and the language embedding; and
updating parameters of the speaker encoder using the loss.

2. The method of claim 1, wherein the speaker encoder is trained to generate the speaker embeddings independent of language-specific characteristics of the training audio signal and the training reference audio signal.

3. The method of claim 1 wherein the speaker encoder is trained:
to embed the training audio signal and the training reference audio signal into a feature space in which the language embedding is embedded;
to place the first speaker embedding and the second speaker embedding close to each other in the feature space; and
to place the first speaker embedding and the language embedding far apart.

4. The method of claim 1, wherein the loss includes a triplet loss which uses the first speaker embedding, the second speaker embedding, and the language embedding as an anchor, a positive sample, and a negative sample, respectively.

5. The method of claim 1, wherein the training text includes a sequence of one or more characters, and
wherein the language identifier includes a sequence of identifiers corresponding to individual characters within the training text.

6. The method of claim 1, wherein training the speech synthesis model further includes:
encoding, by a posterior encoder of the speech synthesis model, a spectrogram of the training audio signal into a latent variable;
outputting, by a decoder of the speech synthesis model, a transformed latent variable based on the latent variable, the language embedding, and the first speaker embedding; and
wherein the decoder is trained to remove language-specific characteristics of the training audio signal by normalizing the latent variable based on the language embedding.

7. The method of claim 6, wherein training the speech synthesis model further includes:
transforming, by a character embedding module of the speech synthesis model, the training text into character embeddings;
encoding, by an encoder of the speech synthesis model, the character embeddings into text feature vectors;
generating, by a projection module of the speech synthesis model, a distribution of the text feature vectors;
estimating, by an alignment data estimator of the speech synthesis model, alignment data based on the transformed latent variable and the distribution of the text feature vectors; and
predicting, by a stochastic duration predictor of the speech synthesis model, a duration associated with speech characteristics of the speaker for each phoneme of the training text based on the first speaker embedding, the text feature vectors, and the alignment data.

8. The method of claim 1, wherein identifying the language identifier includes:
identifying, from among a plurality of audio signals obtained from the speaker, one or more audio signals other than the training audio signal; and
randomly selecting the training reference audio signal among the one or more audio signals.

9. The method of claim 1, wherein training the speech synthesis model further includes:
providing the language embedding and the first speaker embedding as input to sub-networks subsequent to the language embedding module and the speaker encoder to generate a synthesized audio signal corresponding to the training text,
wherein the second speaker embedding is not used for generating the synthesized audio signal.

10. An apparatus comprising:
a memory configured to store instructions;
at least one processor configured, by executing the instructions, to:
receive training text and a training audio signal obtained from a predetermined speaker uttering the training text;
identify a language identifier corresponding to the training text and a training reference audio signal obtained from the speaker uttering reference text different from the training text; and
train a speech synthesis model by using training samples that include the training text, the training audio signal, the language identifier, and the training reference audio signal,
wherein the speech synthesis model comprises:
a language embedding module configured to transform the language identifier into a language embedding; and
a speaker encoder configured to transform the training audio signal and the training reference audio signal into speaker embeddings, and
wherein the at least one processor is further configured to:
determine a loss based on a first speaker embedding transformed from the training reference audio signal, a second speaker embedding transformed from the training audio signal, and the language embedding; and
update parameters of the speaker encoder using the loss.

11. A method comprising:
receiving a speech synthesis request including input text and information on a target speaker;
identifying a language identifier corresponding to the input text and a reference audio signal obtained from the target speaker uttering reference text different from the input text; and
generating, by applying the input text, the language identifier, and the reference audio signal to a speech synthesis model, a synthesized audio signal that simulates speech by the target speaker uttering the input text;
wherein generating the synthesized audio signal includes:
transforming, by a language embedding module of the speech synthesis model, the language identifier into a target language embedding; and
transforming, by a speaker encoder of the speech synthesis model, the reference audio signal into a target speaker embedding, and
wherein the speaker encoder has been trained by using a loss determined based on speaker embeddings transformed from a plurality of training audio signals from a speaker and a language embedding transformed from training text corresponding to one of the plurality of training audio signals.

12. The method of claim 11, wherein the speaker encoder has been trained to generate the speaker embeddings independent of language-specific characteristics of the training audio signals.

13. The method of claim 11, wherein the plurality of training audio signals includes a first training audio signal corresponding to reference text different from the training text and a second training audio signal corresponding to the training text,
wherein the speaker encoder has been trained:
to embed the first training audio signal and the second training audio signal into a feature space in which the language embedding transformed from the training text is embedded;
to place a first speaker embedding transformed from the first training audio signal and a second speaker embedding transformed from the second training audio signal close to each other in the feature space; and
to place the first speaker embedding and the language embedding far apart.

14. The method of claim 13, wherein the loss includes a triplet loss, which uses the first speaker embedding, the second speaker embedding, and the language embedding for the training text as an anchor, a positive sample, and a negative sample, respectively.

15. The method of claim 11, wherein the input text includes a sequence of one or more characters, and the language identifier includes a sequence of identifiers corresponding to individual characters within the input text.

16. The method of claim 11, wherein generating the synthesized audio signal further includes:
outputting, by an inverted decoder of the speech synthesis model, a transformed latent variable based on a latent variable derived from the input text and the reference audio signal, the target language embedding, and the target speaker embedding; and
generating, by an audio generator of the speech synthesis model, the synthesized audio signal from the transformed latent variable.

17. The method of claim 16, wherein outputting the transformed latent variable includes:
conditioning, by the inverted decoder, the latent variable on the target speaker embedding and the target language embedding; and
outputting, by the inverted decoder, the transformed latent variable based on the conditioned latent variable.

18. The method of claim 16, wherein generating the synthesized audio signal from the transformed latent variable includes:
conditioning, by the audio generator, the transformed latent variable on the target speaker embedding, and
generating, by the audio generator, the synthesized audio signal from the conditioned transformed latent variable.

19. The method of claim 16, wherein generating the synthesized audio signal further includes:
transforming, by a character embedding module of the speech synthesis model, the input text into character embeddings;
encoding, by an encoder of the speech synthesis model, the character embeddings into text feature vectors;
generating, by a projection module of the speech synthesis model, a distribution of the text feature vectors;
predicting, by a stochastic duration predictor of the speech synthesis model, a duration associated with speech characteristics of the target speaker for each phoneme of the input text, based on the target speaker embedding and the text feature vectors; and
generating, by an alignment unit of the speech synthesis model, the latent variable based on the distribution of the text feature vectors and the duration predicted for each phoneme.

20. An apparatus comprising:
a memory configured to store instructions; and
at least one processor configured, when executing the instructions, to perform the method of claim 11.
